(19) United States
(12) Patent Application Publication
(10) Pub. No.: US 2001/0037384 A1
(43) Pub. Date: Nov. 1, 2001

(54) System and method for implementing a virtual backbone on a common network infrastructure

(76) Inventors: Brian Jemes, Moscow, ID (US); John M. Pape, Fort Collins, CO (US); Joseph Garcia, Mountain View, CA (US); Michael Milligan, Fort Collins, CO (US)

Correspondence Address: HEWLETT-PACKARD COMPANY, Intellectual Property Administration, P.O. Box 272400, Fort Collins, CO, 80528-9599, US

(21) Appl. No.: 09/795,778

(22) Filed: Feb. 27, 2001

Related U.S. Application Data
(60) Provisional application No. 60/204,229, filed on May 15, 2000.

(51) Int. Cl. G06F 15/173

(52) U.S. Cl. 709/223; 709/238

(57) ABSTRACT

A secure network system is provided which includes a plurality of networks where each network has at least one network device configured to transmit and receive data and has a network security policy. The secure network further includes a plurality of network control points where each network control point has at least one network control point device. Each of the plurality of network control points is connected to at least one of the plurality of networks. All network control point devices are configured to enforce the network security policy for the network to which it is connected. The secure network further includes a virtual backbone configured to connect the plurality of network control points to one another. The virtual backbone does not enforce any network security policy with respect to data being transmitted across the virtual backbone, except for source address integrity at the point the networks connect to a NCP.

### CROSS-REFERENCE TO RELATED APPLICATION

This application claims priority from U.S. provisional patent application Serial No. 60/204,229, filed May 15, 2000, which is herein incorporated by reference for all purposes.

### BACKGROUND OF THE INVENTION

1. Field of the Invention

The present invention relates particularly to systems and methods for providing network security and, more particularly to systems and methods for implementing a virtual backbone on a common network infrastructure.

2. Description of the Related Art

Company networks are vulnerable to numerous network attacks. Network firewalls or similar approaches are deployed as a common business practice to mitigate the risk of such attacks. Typically these security measures allow for unrestricted connectivity within the company or among a known collection of host devices, but they restrict access from public networks and other organizations or unknown devices. For example, the company may allow employees to access any web site on the public Internet, but prohibit access to confidential internal web sites by unknown users from public networks.

Several types of devices have been developed that perform network firewall functions. One commonly known device is a router, which is a device that determines the next network point to which a packet of information is to be delivered. Before the packet is forwarded to another device, the router may use an access list that provides conditions or rules to determine whether the packet has access to the particular destination. In addition, these devices may provide functions such as user authentication. Also, application proxies, e.g., socks and caching web proxies, allow specific applications to be executed for network security and might also employ user authentication. Companies typically have a network security policy that describes the type of access that should be permitted through firewall devices. This policy is achieved through the application of a combination of the network firewall devices described above.

FIG. 1 is a simplified block diagram of a prior art network security system 10 illustrating a plurality of networks in different geographic locations that are connected to an enterprise backbone 12. The enterprise backbone is part of the company's internal network and is generally maintained by the company. The enterprise backbone comprises a plurality of networks having the property that the public internet and business partners are not permitted to spoof known networks. The enterprise backbone is configured to carry data from one location to another. The plurality of networks might include the public Internet 14, business partners 16, and known networks 18. Network firewalls 20 are used to connect the public Internet and business partner networks to the enterprise backbone and provide security management for the entire network system. Known networks connect directly to the enterprise backbone and do not connect to network firewalls. Each network may be connected to multiple network firewalls. For example, business partner 2 is connected to two network firewalls. Each network firewall must be configured to enforce a particular network security policy and one or more network firewalls 20.

Another common network security system that has been implemented by many companies is the concept of dividing the networks into three categories: internal, external, and De-Militarized Zone (DMZ). This type of network security policy is defined by the access permitted between these network categories. That is, the network firewall 20 is made up of devices that provide the interconnections between these network categories. The network firewall is located between the internal network and the external network, e.g., the public Internet 14, and at any direct links to other companies. End-user hosts, internal servers and known networks 18 are part of the internal network. The public Internet and other company networks, e.g., business partners 16, are part of the external network. Web servers, email servers and other application servers (not shown) that require general connectivity with the external network are part of the DMZ. The internal network is connected to the external network and the DMZ via the enterprise backbone 12.

A common network security policy may be that internal systems are permitted to create connections to the external networks, but connections from the external network to the internal network are not permitted, unless they are accompanied by user authentication. In addition, the DMZ hosts are permitted to have connectivity to the external networks and the internal networks independently, but are not permitted to allow “pass-through” connectivity from the external networks to the internal networks. An exception to the common network security policy might be configured into the network firewall when, for example, a DMZ or external network may have a particular user or host that must be permitted access to a particular host in the internal network.

The internal, external, and DMZ architecture, however, has many drawbacks. For example, if the company network has multiple external connections to the public Internet that are in different geographic locations, wide-area asymmetric routing to the public Internet is likely. That is, inbound and outbound data for a given connection will not pass through the same firewall device and therefore firewall policies that rely on inspection of the protocol state will fail, because the protocol state will reside in two different firewall devices. In Internet Protocol (IP) networks, technologies such as Network Address Translation (NAT) may be used to work around this problem, but these technologies do not address the underlying issue and often introduce problems in large or complex networks. Currently, no technology is generally available for synchronizing the protocol state between firewall devices in separate geographic locations.

In addition, this architecture is limited to having only one internal network, which exposes the company to great risks if an unauthorized user gains access to the internal network. This architecture also does not allow the company the option of segmenting risk. Hence, a risk taken by one host in the internal network is a risk taken indirectly by all the other hosts in the internal network. This becomes apparent when considering the above exception to the common network security policy. The risk to all the internal hosts is greatly increased for every host in the external network that is permitted access to the internal network via the network firewall or DMZ.

This architecture is further limited due to its difficulty in maintaining a uniform firewall policy for firewall devices that are across geographic locations and company units. Each firewall device has a combination of a number of diverse and complex rules that reflect the overall security policy and the specific exception cases required at that specific firewall. Each of these firewalls represents a risk to the entire company. If there is a simple misconfiguration on any firewall device, the entire internal network is exposed to an unintended security breach or unwanted behavior. As the number of firewalls increase, the likelihood of security exposure increases dramatically.

Another network security architecture includes establishing concentric rings of network access control. This architecture allows the most sensitive information resources to be kept in the innermost rings, while the most common information resources to be kept in the outermost rings. External networks are outside of the outermost ring. The network security policy for the outer rings is fairly permissive, while the network security policy for the inner rings is much more restrictive.

One limitation of the concentric ring architecture is that some connections are required to traverse multiple firewalls for communication between two hosts at different levels. For example, if there are four firewall rings, then the external hosts have to traverse four firewalls before gaining access to the inner host in the innermost ring. For each additional firewall traversed, the time required to access the inner host is increased.

Another limitation is that the network security policy for the inner rings is limited by the policy enforced for the outer rings. Therefore, it is not possible for the inner ring to permit connectivity from external networks that is disallowed by an outer ring. For example, it is impossible for an inner ring to allow the incoming telnet access, unless that access is also granted at each of the outer rings of security.

These limitations described above for the various network security architectures apply to networks of any size, but become more severe when considering large or highly distributed networks. A Network Service Provider (NSP), Internet Service Provider (ISP), Application Service Provider (ASP), E-Service Provider (ESP), or a large company or enterprise may have over 100 firewalls around the world where a network security policy must be administered. Using the network architectures described above, it is almost impossible to ensure that the policies are consistent and error-free at each of the firewalls.

Another drawback for large enterprises or service providers with firewalls is that the network security policy governing any given hosts must be configured consistently at all the O(n) firewalls, where n is the number of firewalls for the enterprise. This creates a lot of redundant work and greatly increases the likelihood of error in configuration. Also, this can lead to a lack of direct accountability for the network security policy. To determine the network security policy for any given host, the network security policy must be examined at every firewall across the enterprise. The network security policy implemented at firewalls that are topologically distant from the host have an equal role in determining the enterprise network security policy for that host.

Therefore, it should be appreciated that there is a need for systems and methods that overcome the above drawbacks and limitations. The present invention fulfills this need as well as others.

### SUMMARY OF THE INVENTION

A secure network system is provided which includes a plurality of networks where each network has at least one network device configured to transmit and receive data and has a network security policy. The secure network further includes a plurality of network control points where each network control point has at least one network control point device. Each of the plurality of network control points is connected to at least one of the plurality of networks. All network control point devices are configured to enforce the network security policy for the network to which it is connected. One exception is that connections between the NCPs of the same virtual backbone do not have a network security policy enforced between the NCPs of the same virtual backbone. The secure network further includes a virtual backbone configured to connect the plurality of network control points to one another. The virtual backbone does not enforce any network security policy with respect to data being transmitted across the virtual backbone, except for source address integrity at the point the networks connect to a NCP. Additionally some other policies may be enforced at connections to networks which might provide protection against attacks or misuses, such as denial of service attacks. Each virtual backbone may have an address registry of the address ranges of the plurality of networks connected to the virtual backbone via one or more of the plurality of network control points.

### BRIEF DESCRIPTION OF THE DRAWINGS

Embodiments of the present invention will now be described, by way of example only, with reference to the following drawings in which:

FIG. 1 is a simplified block diagram of a prior art network security system illustrating a plurality of networks in different geographic locations that are connected to an enterprise backbone;

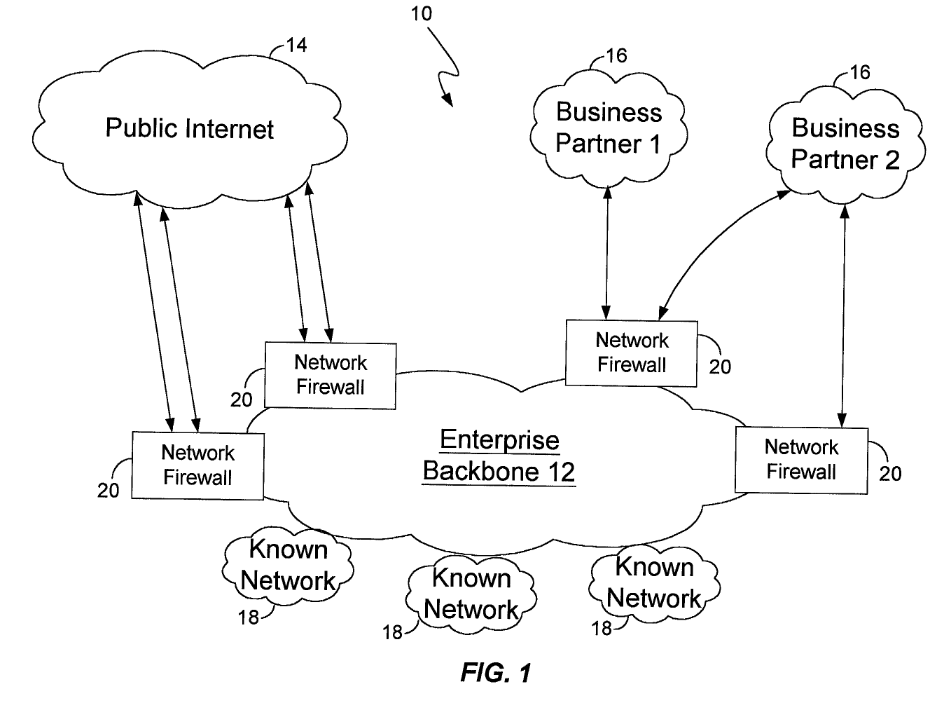

FIG. 2 is a simplified block diagram of a network security system having a plurality of networks, a plurality of network control points, and a virtual backbone;

FIG. 3 is a simplified block diagram of a network security system where two independent companies or enterprises have implemented a portion of the network security system of FIG. 2; and

FIG. 4 is a simplified block diagram illustrating a network security system where two or more companies or enterprises share the same known network.

### DESCRIPTION OF THE PREFERRED EMBODIMENT

In this patent, the present invention is described in detail with regard to the drawing figures briefly described below. Similar labels and numbers on one drawing figure may represent the same element on other drawing figures. The following terms are used throughout the patent. For purposes of construction, such terms shall have the following meanings:

The terms “network access policy” and “network security policy,” unless otherwise specified, are intended to refer to one or more rules or criteria that govern the movement of data across a network control point.

The term “network control point,” unless otherwise specified, is intended to refer to a physically co-located collection of one or more devices that perform one or more of the following functions: interconnect network control point devices, interconnect network control points, and/or enforce a network security policy. In an IP network, each NCP's IP address is in the virtual backbone and the known network that it is connected to.

The term “virtual backbone,” unless otherwise specified, is intended to refer to a network(s) that connects a plurality of network control points having the property of source integrity (e.g., anti-spoofing).

The term “unknown network,” unless otherwise specified, is intended to refer to all networks and devices that are not part of any known network. In an IP network, the unknown network includes the hosts and networks in the public Internet or private networks that are not part of known networks. In as much as they are unknown, no assumptions can be made with regard to connectivity between devices in the unknown network, nor can source integrity be assumed. Each unknown network can connect to one or more network control points (NCP).

The term “known network,” unless otherwise specified, is intended to refer to all networks with known network security policies and known address space. Each known network can connect to one or more NCPs.

The term “network device,” unless otherwise specified, is intended to refer to a device connected to a network or a device that is part of a network. The network device can be, e.g., a host, client, server, workstation, desktop, laptop, printer, router, and switch.

The term “address registry,” unless otherwise specified, is intended to refer to a collection of information describing the address ranges in all the known networks of a virtual backbone. The address registry may be embodied in a document, a tool, or application with processes and procedures for the acquisition, maintenance, and distribution of this information.

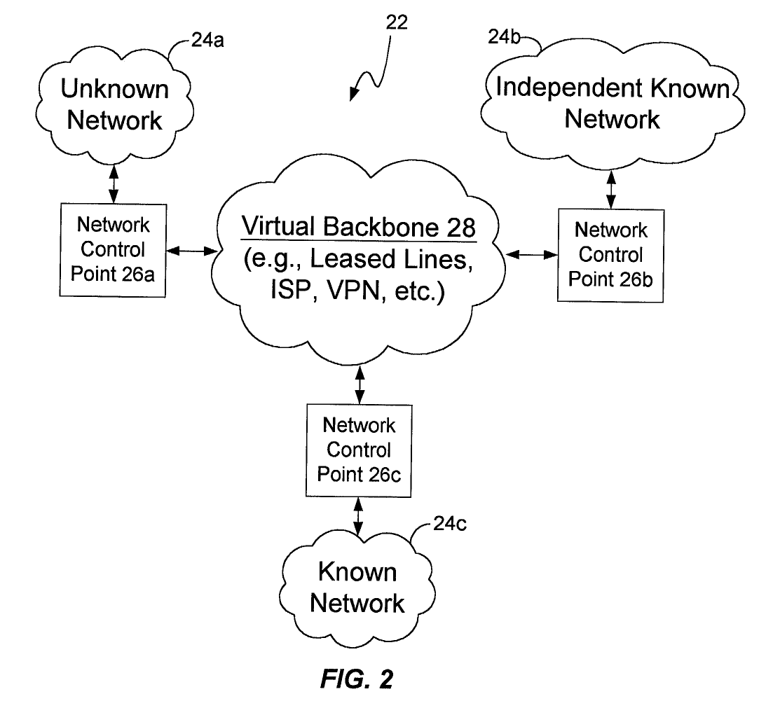

With reference now to the illustrative drawings, and particularly to FIG. 2, there is shown a simplified block diagram of a network security system 22 having a plurality of networks 24, a plurality of network control points 26, and a virtual backbone 28. Each of the plurality of networks is connected to the virtual backbone via one or more network control points.

The plurality of networks include unknown network 24a, independent known network 24b, and known network 24c. That is, each of the plurality of networks can be an unknown network or a known network. The unknown networks might include networks that are unknown to the company or enterprise. The unknown network might represent the public Internet or a Business Partner network about which no security assumptions can be made. A device in the unknown network might or might not be able to access other devices that are located in the unknown network. The independent known networks are networks that the company knows about but are not controlled by the company. Known networks are networks that the company owns. A device in the unknown network 24a might or might not be able to access data from a device in a known network 24c. Whether a device in an unknown network can access data from another device in a known network depends on the network security policy of the known network as enforced by the network control point 26c.

In the case of an IP network, the plurality of networks are defined by address ranges corresponding to one or more devices. In IP networks, address ranges are defined by a base address and a mask applied to the address to determine if an address is included in the range. Alternatively, the plurality of networks may be defined by the placement of a network access point which uses a security mechanism to establish that a wireless device is a legitimate node in a given wireless network. Other factors can be applied to distinguish networks based on the underlying network technology used.

Each network control point 26 includes one or more network control point devices, which are used to connect one or more of the plurality of networks 24 to the virtual backbone 28. Depending on the type of networks, routing, and security policy requirements, the network control point devices may be routers with access lists, a dedicated network firewall device, or any appropriate device capable of enforcing source integrity, network security policy, and routing functions. A combination of devices performing these functions may also be used to achieve the desired functionality. By way of example, in the case of an Internet protocol (IP) network, the network control point device might be a router, or a dedicated network firewall device. In the case of a wireless network, the network control point device can include a wireless access point connected to a device to route data. The network control point device might implement an access list to enforce the network security policies.

Network control point devices are used to route data and/or enforce a network security policy for known networks 24c. For example, data can be routed from unknown network 24a to known network 24c, and vice versa, using the network control points 26a, 26c and the virtual backbone 28. The network control point 26c can enforce the network security policy for the known network 24c. By way of example, this could be done in an IP network using a routing device capable of determining from the destination IP address that the data received on network control point 26a should be sent to known network 24c. In addition, the network control point devices can enforce the network security policy of the network control points 26b, 26c. By way of example, in an IP network, routing devices can be used to enforce rules based on the protocol used or other characteristics such as originating and destination IP address. Further, a wide variety of other devices can perform this function with differing levels of sophistication.

In an IP network, one network security policy decision that can be made by the network control point 26 involves allowing or restricting access based on the source IP address, i.e., anti-spoofing. Anti-spoofing means that the network control point device will block data marked as originating from an address that is not part of the valid address range for a particular known network. More advanced devices can allow or restrict access by applying rules based on various protocols or an analysis of the context of a connection. The later capability is generally called stateful inspection. The source address of all networks must be strictly enforced at the network control points to all known networks. At connections to unknown networks, the source address must not be that of a known network. The minimum network security policy for the virtual backbone is that it will enforce source address integrity on its external connections, that is, not allowing unknown networks to send data that masquerade as being sourced from address space included in a known network implementation, or reserved for implementation. Also, the network security policy provides that known networks cannot masquerade as any other network, except the network that it is “known” to be.

The virtual backbone 28 is a network that connects to a plurality of network control points 26. The virtual backbone can be implemented using one or more of the following: communication lines, e.g., T1, DS3, OC-3, an Internet service provider (ISP), a VPN, e.g., IPsec, a private network, switched and permanent virtual circuit network transmission technologies, e.g., frame relay and asynchronous transfer mode, multi-access transmission technologies, e.g., switched multimegabit data service, or any other wired or wireless network. The virtual backbone is outside the network control points 26 and is external to all of the plurality of networks. The networks 24 themselves are not part of the virtual backbone, so they must utilize separate real or virtual equipment for LAN and WAN infrastructure that is contained entirely within its network. This allows for a consistent network security policy for each network that may be managed and maintained independent of the virtual backbone that is used to interconnect network control points. In one embodiment, a LAN link is used to connect network control point devices within a network control point and a WAN link is used to connect the network control points to the virtual backbone. These LAN and WAN links between NCPs make up the virtual backbone. The equipment used in the LAN and WAN links might include a switch, bridge, hub, and an Ethernet link.

Typically, an enterprise will have one virtual backbone 28, and service providers may have one or more virtual backbones depending upon the needs of their customers and the networking requirements imposed by their customer's needs. The number of virtual backbones is a function of implementation of the invention and has no bearing on the operation of the resulting network. Alternatively, the enterprise might have more than one virtual backbone, where each has a set of known networks. More than one virtual backbone can know the address space of a particular known network, e.g., 24c. Also, one virtual backbone can be connected to another virtual backbone to increase the total number of known networks available for access. The virtual backbone can be owned and maintained by an entity other than the enterprise, and can be shared by multiple independent enterprises. For example, the virtual backbone can be implemented using an ISP. The virtual backbone can be an external network established and implemented by a number of ISPs. A VPN link may use any number of ISPs to provide a virtual backbone connection. The intermediate ISPs do not need to provide assurance that source address integrity and privacy will be maintained, because this will be provided by the VPN, and the integrity and privacy of the virtual backbone will be maintained. Even though each ISP has security policies to enforce source address integrity, these policies may not be uniform or provide any security assurances with respect to data being transmitted across the virtual backbone. Alternatively an ISP may provide a value-added service where source address integrity is strictly enforced for known networks, which might alleviate the need for VPNs.

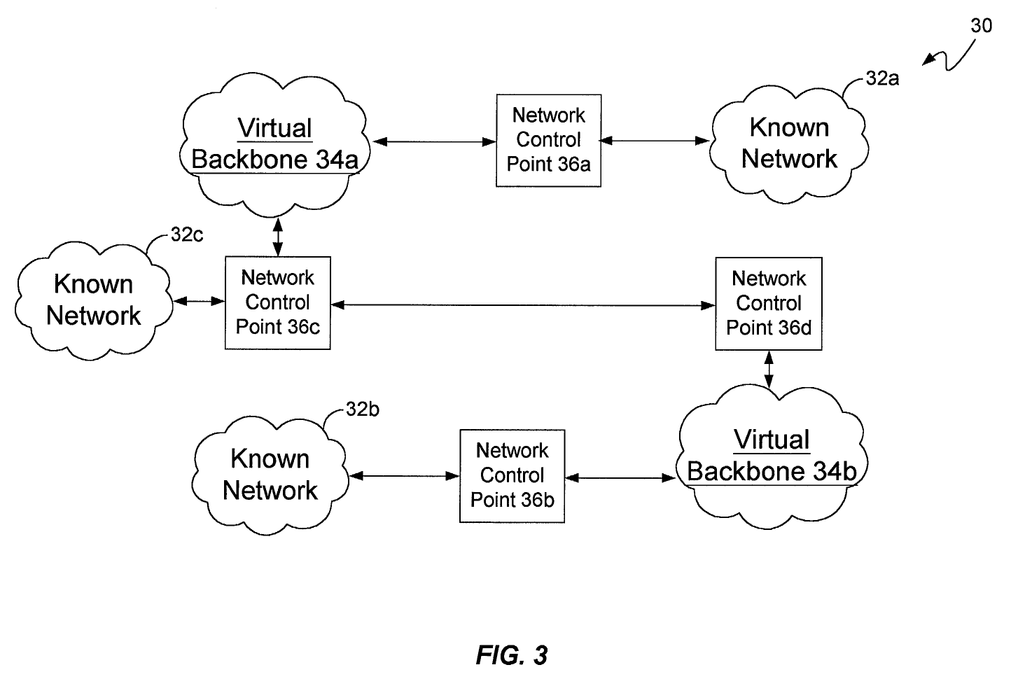

FIG. 3 is a simplified block diagram of a network security system 30 where two independent companies or enterprises have implemented a portion of the network security system of FIG. 2. At least one network control point device in network control point 36c is connected to at least one network control point device in network control point 36d. Each network control point 36a, 36b enforces the network security policy of its respective known network 32a, 32b. Before two devices: one in known network 32a, and one in known network 32b can have access as known networks, the known network 32a of virtual backbone 34a should be permitted at NCP 36b and known network 32b of virtual backbone 34b should be permitted at NCP 36a. Virtual backbone 34a needs to know the address registry of virtual backbone 34b and vice versa. Otherwise network 32a and network 32b would be unknown to each other. Network control points 36c, 36d enforce source address integrity and anti-spoofing for both virtual backbones 34a, 34b. In addition, network control point 36c enforces the network security policy for data enroute to its known network 32c.

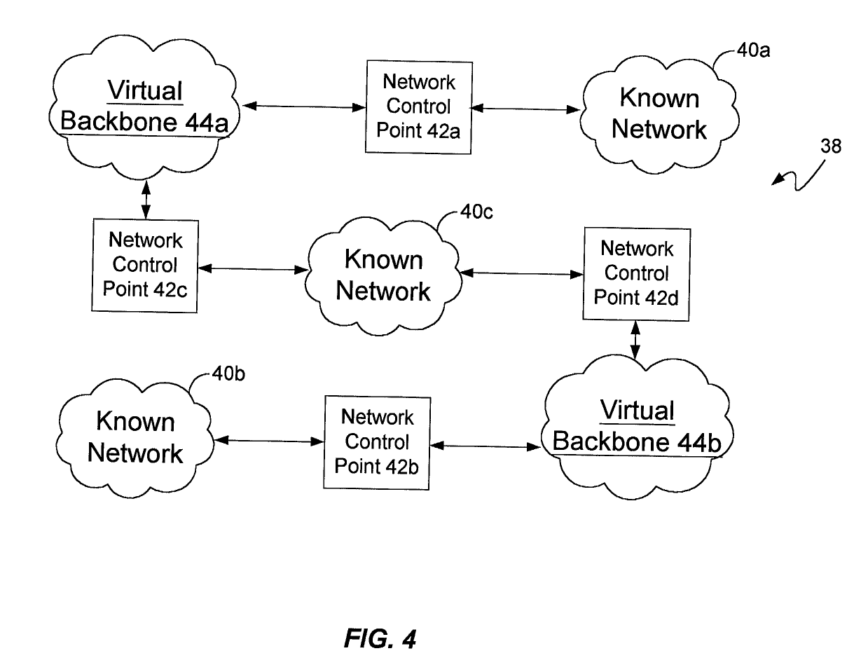

FIG. 4 is a simplified block diagram illustrating a network security system 38 where two companies or enterprises share the same known network 40c. The known network 40c is connected to a virtual backbone 44a and 44b via a network control point 42c and 42d. The number of companies sharing the known network is at least equal to the number of network control points. In this example, since there are two companies sharing the known network, there are two network control points. Each company's network security policy is enforced at its network control point. For example, company A's network security policy is enforced at network control point 42a. Similarly, company B's network security policy is enforced at network control point 42b. Hence, even though the companies share the known network 40c, each company does not have to enforce the same network security policies at each network control point 42a, 42b. Each company also has its own private network, which is depicted as known network 40a and 40b. Network control points 42a, 42b enforce the network security policy of known networks 40a, 40b. Network control points 42c, 42d enforce source address integrity and anti-spoofing for their respective virtual backbone 44a, 44b.

The foregoing detailed description of the present invention is provided for the purposes of illustration and is not intended to be exhaustive or to limit the invention to the precise embodiment disclosed. Several embodiments of the network security system have been described that are provided for the purposes of illustration and are not intended to be exhaustive or to limit the invention to the precise embodiment disclosed. The embodiments may provide different capabilities and benefits depending on the configuration used to implement the network security system. Accordingly, the scope of the present invention is defined by the following claims.

What is claimed is:

1. A network system configured to carry data, comprising:
a plurality of networks, each network having at least one network device configured to transmit and receive data and having a network security policy;
a plurality of network control points, each network control point having at least one network control point device, wherein each of the plurality of network control points is connected to at least one of the plurality of networks, and wherein at least one of the network control point devices is configured to enforce the network security policy of the network that is connected to the network control point device; and
a virtual backbone configured to connect the plurality of network control points to one another.

2. A network system as defined in claim 1, wherein the virtual backbone does not enforce any network security policy with respect to data being transmitted across the virtual backbone.

3. A network system as defined in claim 1, wherein the virtual backbone has a registry that stores an address range of the plurality of known networks that are connected to the virtual backbone.

4. A network system as defined in claim 1, wherein the virtual backbone is implemented using one or more of the following: communication lines, an internet service provider, a virtual private network, and a public network.

5. A network system as defined in claim 1, wherein the virtual backbone is external to the plurality of networks.

6. A network system as defined in claim 1, wherein the virtual backbone is external to the plurality of network control points.

7. A network system as defined in claim 1, wherein the virtual backbone is configured to enforce source address integrity.

8. A network system as defined in claim 1, wherein at least one of the network control point devices in each of the plurality of network control points has unrestricted network connectivity to at least one of the network control point devices within all of the other network control points within the same virtual backbone.

9. A network system as defined in claim 1, wherein each of the plurality of networks is defined by an address range.

10. A network system as defined in claim 9, wherein each of the network devices in each of the plurality of networks has an address contained within the address range.

11. A network system as defined in claim 1, wherein each of the plurality of network control points ensures source address integrity.

12. A network system as defined in claim 1, wherein the virtual backbone is an external network established and implemented by a plurality of internet service providers.

13. A network system configured to carry data, comprising:
a virtual backbone;
a plurality of network control points, each network control point having at least one network control point device, which is connected to the virtual backbone and configured to enforce a network security policy of a known network;
a plurality of known networks, each known network is connected to at least one of the plurality of network control point devices and has a network security policy; and
a plurality of unknown networks, each unknown network is connected to at least one of the plurality of network control point devices, and having no network security policy.

14. A network system as defined in claim 13, wherein the virtual backbone has a registry that stores an adress range of the plurality of known networks that are connected to the virtual backbone.

15. A network system as defined in claim 13, wherein the virtual backbone is an external network established and implemented by a plurality of internet service providers.

16. A network system as defined in claim 13, wherein the virtual backbone is external to the plurality of known networks.

17. A network system as defined in claim 13, wherein the virtual backbone is external to the plurality of network control points.

18. A network system as defined in claim 13, wherein at least one of the network control point devices in each of the plurality of network control points has unrestricted network connectivity to at least one of the network control point devices within all of the other network control points within the same virtual backbone.

19. A network system as defined in claim 13, wherein each of the plurality of known networks is defined by an address range.

20. A network system as defined in claim 19, wherein each of the network devices in each of the plurality of known networks has an address contained within the address range.

21. A network system as defined in claim 13, wherein the virtual backbone is configured to enforce source address integrity.

22. A network system as defined in claim 13, wherein each of the network devices in each of the plurality of known networks has unrestricted network connectivity to all other network devices within the same known network.

23. A network system as defined in claim 13, wherein each of the plurality of network control points ensures source address integrity.

24. A network system as defined in claim 13, wherein the virtual backbone is implemented using one or more of the following: communication lines, an internet service provider, a virtual private network, and a public network.

25. A network system configured to carry data, comprising:
first and second known networks;
first and second virtual backbones, each virtual backbone having an address registry, which includes addresses corresponding to network devices in the first and second known networks;
a first network control point configured to connect the first known network to the first virtual backbone and configured to enforce a network security policy of the first known network;
a second network control point configured to connect the second known network to the second virtual backbone and configured to enforce a network security policy of the second known network;
a third network control point configured to connect to the first virtual backbone and configured to enforce source address integrity for the first and second virtual backbones; and
a fourth network control point configured to be coupled to the third network control point and the second virtual backbone and configured to enforce source address integrity for the first and second virtual backbones.

26. A network system as defined in claim 25, further comprising a third known network configured to connect to the third network control point.

27. A network system as defined in claim 26, wherein the third network control point is configured to enforce a network security policy of the third known network.

28. A network system as defined in claim 26, wherein the third known network is configured to connect to the fourth network control point.

29. A network system as defined in claim 26, wherein the fourth network control point is configured to enforce a network security policy of the third known network.

30. A network system as defined in claim 25, wherein the first and second virtual backbones are external networks established and implemented by a plurality of internet service providers.

31. A network system as defined in claim 25, wherein the first and second virtual backbones are external to the first and second known networks.

32. A network system as defined in claim 25, wherein the first and second virtual backbones are external to the network control points.

33. A network system as defined in claim 25, wherein the first and second virtual backbones are configured to enforce source address integrity.

34. A network system as defined in claim 25, wherein all of the network devices in the first and second known networks have unrestricted network connectivity to all other network devices within the same known network.

35. A network system as defined in claim 25, wherein the first, second, third, and fourth network control points ensure source address integrity.

36. A network system as defined in claim 25, wherein the first and second virtual backbones are implemented using one or more of the following:
communication lines, an internet service provider, a virtual private network, and a public network.
